(19) United States
(12) Patent Application Publication
(10) Pub. No.: US 2013/0157371 A1
(43) Pub. Date: Jun. 20, 2013

(54) Anaerobic Digestion Process Monitoring Device and Method Thereof

(71) Applicants: Christopher J. Ferguson, Lakefield (CA); Lawrence D. Gibson, Peterborough (CA)

(72) Inventors: Christopher J. Ferguson, Lakefield (CA); Lawrence D. Gibson, Peterborough (CA)

(73) Assignee: Carbon Control Systems Inc., Peterborough (CA)

(21) Appl. No.: 13/638,326

(22) PCT Filed: Mar. 30, 2011
(86) PCT No.: PCT/CA11/00347

§ 371 Date: Mar. 6, 2013

Related U.S. Application Data
(60) Provisional application No. 61/319,812, filed on Mar. 31, 2010.

(51) Int. Cl. G01N 7/18

(52) U.S. Cl. CPC G01N 7/18
USPC 436/43; 422/82.13; 436/129; 422/63

(57) ABSTRACT

Disclosed herein are a device and method for accurately extracting individual organic acid and/or Total Volatile Fatty Acid (VFA), ammonium (NH₄⁺) and buffering inorganic carbon compound or hydrogen carbonate (HCO₃⁻) concentrations trends from an active Anaerobic Digestion (AD) process. The substantially real-time individual and/or total VFA, NH₄⁺ and HCO₃⁻ information allows the AD operator to effectively operate the system at optimal efficiency and ensure that VFA and NH₄⁺ concentrations do not reach toxic levels that can potentially cause the AD process to fail. The general health of an AD digester and process may be determined by using a ratio of total organic acids to total inorganic carbon as determined by the method.

### CROSS REFERENCE TO RELATED APPLICATIONS

This application is related to and claims benefit of priority to U.S. Provisional Patent Application Ser. No. 61/319,812, entitled “ON-SITE REAL-TIME ANAEROBIC DIGESTION PROCESS MONITORING DEVICE AND METHOD THEREOF”, and filed Mar. 31, 2010, the disclosure of which is herein fully incorporated by reference.

### FIELD

The present disclosure relates to a device and method for monitoring of compounds in anaerobic digesters.

### BACKGROUND

The main rationale for monitoring individual volatile fatty acids (VFA), also termed herein as total organic acids (FOS), and the associated buffering capacity in an anaerobic digestion system is to understand the bio-chemical state of the anaerobic digester (AD) system. When these bio-molecules accumulate and the buffering capacity is depleted an AD system failure is imminent. AD process failures are very expensive to correct and can severely affect the economics of the AD installation. Furthermore in the event of an anaerobic digester failure due to incorrect bio-molecular balancing, the digester often must be “restarted” in order to restore the AD system to a proper functioning of the system.

The current commercially viable, state of the art in AD bio-chemical monitoring includes on-site buffering capacity, indicated by hydrogen carbonate (HCO₃⁻) concentrations, which can be determined by the AD operator using a titration method so as to determine the total inorganic carbonate (TAC). Whereas individual VFA analysis requires the AD operator to freeze samples taken from the active AD process and then send the samples to an offsite laboratory. The samples are then thawed at the offsite laboratory and prepared for analysis. Typically, the analysis is performed by a Gas Chromatography—Flame Ionized Detection (GC-FID) instrument. The GC-FID instrument typically quantifies the concentration of acetic, propionic, butyric, iso-butyric, valeric and iso-valeric acids within the sample that originated from the AD process so as to determine the FOS levels. Ammonium (NH₄⁺) monitoring can be done on-site using a titration method or at an offsite laboratory when the sample is thawed.

Conventionally in order to determine the TAC and FOS (VFA) concentrations on-site in an AD digestion process, a sample of a desired quantity is taken from an active digester in an AD process. The sample is placed in a vessel and continuously stirred. An initial pH measurement of the sample is taken and the sample is then titrated with 0.1M of sulphuric acid. The volume of sulphuric acid required to lower the pH of the same to a pH of about 5 is recorded. The titration using sulphuric acid is continued and the amount of acid required to further lower the pH from about 5 to a pH value of about 4.4 is recorded. The concentration of TAC is determined by molar calculations using the value of the amount of the sulphuric acid required to bring the pH of the sample to 5. The concentration of FOS is similarly determined by molar calculations using the value of the amount sulphuric required to bring the pH to 4.4 from 5. The “health” of the AD digester is then indicated by determining the ratio of FOS to TAC by dividing the calculated concentration value of FOS by the calculated concentration value of TAC in the sample. For example, the health of a digester may be determined by the ratio of FOS to TAC wherein a value of less than 0.5 indicates that the AD digester is in good health and is substantially optimized in terms of the quantity of VFA and HCO₃⁻ buffering capacity. In situations where in the FOS/TAC value exceeds 0.5, the AD digester may be considered to be in poor health and corrective action should be taken by an operator.

There are many drawbacks with these methods of AD monitoring. When the individual VFA analysis is done off-site, the turnaround time for obtaining the VFA data can be 2-7 days, which delays corrective action and can lead to AD failure. Another major drawback is that the off-site individual VFA analysis and the on-site NH₄⁺, HCO₃⁻ concentration analysis is labour intensive and time consuming. Furthermore, the titration methods can also be slow to execute and prone to human errors given the number of manual steps required. Therefore, there is a need for a new on-site real-time anaerobic digestion process monitoring device and method thereof that overcomes at least some of the drawbacks of known techniques, or least, provides the public with a useful alternative.

This background information is provided to reveal information believed by the applicant to be of possible relevance to the invention. No admission is necessarily intended, nor should be construed, that any of the preceding information constitutes prior art against the invention.

### SUMMARY

The following presents a simplified summary of the foregoing disclosure to provide a basic understanding of some aspects of the invention. This summary is not an extensive overview of the invention. It is not intended to restrict key or critical elements of the invention or to delineate the scope of the invention beyond that explicitly or implicitly described by the following description and claims.

In an exemplary embodiment, a device for monitoring compound concentrations in an anaerobic digestion system is provided. The device comprises a selectively sealable sample chamber including an inlet liquid transfer portion located near a bottom portion of the sample chamber in operable communication with an anaerobic digester. The liquid transfer portion has a valve operable between an open position and a closed position for allowing the selective transfer of a liquid sample from the anaerobic digester into the sample chamber. The sample chamber is provided at an elevation relative to an anaerobic digester liquid level so as to provide a sample chamber gas head-space when the valve is in an open position and the liquid sample and digester liquid are in equilibrium. A gas valve capable of a gas valve-open conformation and a gas valve-closed confirmation is provided in operable communication between the sample chamber gas head-space and an anaerobic digester head-space for selectively allowing the equilibrated transfer of the liquid sample from the anaerobic digester into the sample chamber and evacuation of the liquid sample chamber. The sample chamber has an agitator for agitating the liquid sample and a heater for heating the liquid sample. Furthermore, the sample chamber has an inlet for introducing a desired amount of an acid into the liquid sample and a pressure sensor located near a top portion of the sample chamber for measuring gas pressure in the sample chamber gas head-space and determining a concentration of buffering inorganic carbon compounds in the liquid sample therefrom. A gas condenser unit is also provided and located in the sample chamber gas head-space for condensing gases in the head-space. A transfer portion is operably coupled between the gas condenser unit and a detection module for extracting a sample of condensed gases and determining the concentration of organic acids in the condensed gases therefrom by the detection module and a data processing module coupled to the pressure sensor. The detection module is provided for recording and monitoring the concentrations of buffering inorganic carbon compounds and organic acids in the liquid sample at a given time point.

In some exemplary embodiments, the organic acids are volatile fatty acids.

In some exemplary embodiments, the agitator provides sufficient agitation so as to substantially inhibit components of the liquid sample from adhering to the sample chamber walls. Furthermore, in some exemplary embodiments, the agitator is a motor-driven agitator.

In some exemplary embodiments, the acid introduced into the sample chamber is hydrochloric acid, sulfuric acid or phosphoric acid.

In some exemplary embodiments the gas pressure in the sample chamber gas head-space is substantially provided by an increase in carbon dioxide resultant from the reaction of the acid with hydrogen carbonate in the liquid sample.

In some exemplary embodiments, the gas condenser unit includes distillation means for removing at least a portion of water from the condensed gases.

In some exemplary embodiments, the detection module includes a Fourier Transform Infrared (FT-IR) Spectrometer, a Fourier Transform Near Infrared Spectrometer (FT-NIR), a Near Infrared (NIR) Dispersion spectrometer, a Gas Chromatographer (GC), GC-FID, a High Performance Liquid Chromatography (HPLC) system, a High Performance Liquid Chromatography (HPLC) system configured with an ultraviolet detector, or a tuned laser-diode combination detection system.

In some exemplary embodiments, the device includes an automated control module for coordinating the inlet of the liquid sample into the sample chamber, the inlet of acid into the sample chamber, the agitator, the heater and/or the processing module in a predetermined sequence. Furthermore, in some exemplary embodiments the automated control module also coordinates the inlet of a base into the sample chamber.

In some exemplary embodiments, the device includes a gas pump and a gas transfer portion in operable communication for transferring gases from the anaerobic digester head-space to the sample chamber gas head-space so as to selectively evacuate the liquid sample from the sample chamber when the liquid transfer portion valve is in the open position.

In some exemplary embodiments, the device includes a base input mechanism operably coupled to the sample chamber for introducing a desired amount of a base into the liquid sample.

In some exemplary embodiments, a method for the quantification of compounds in an anaerobic digestion process for monitoring a substantially constant anaerobic digestion process is provided. The method comprising:
a. extracting a liquid sample from an anaerobic digester and introducing the liquid sample into a selectively sealable sample chamber such that a sample chamber gas head-space remains near a top portion of the sample chamber;
b. adding a desired amount of an acid to the liquid sample so as to produce a liquid sample and acid combination;
c. agitating the liquid sample and acid combination so as to decrease the pH of the liquid to about 4.4 or less and produce carbon dioxide gas therefrom wherein at least a portion of the carbon dioxide gas is released into the sample chamber gas head-space;
d. determining a first gas pressure in the sample chamber gas head-space so as to determine the concentration of buffering inorganic carbon compounds in the liquid sample therefrom;
e. heating and agitating the sample so as to cause the release of organic acids into sample chamber gas head-space;
f. collecting and removing at least a portion of the organic acids from the sample chamber gas head-space and analyzing the concentration of the organic acids in the portion collected from the sample chamber gas head-space so as to determine the concentration of organic acid in the liquid sample therefrom; and
g. determining a ratio of the concentration of organic acids in the sample to the concentration of the buffering inorganic carbon compounds in the liquid sample so as to provide an indication of the health of the anaerobic digestion process.

In some exemplary embodiments, the method further comprises repeating (d) so as to provide more than one gas pressure reading from the sample chamber gas head-space and further comprises: i) determining the amount of the buffering inorganic carbon compounds evolved to carbon dioxide for each repetition; and ii) summing the amount of the buffering inorganic carbon compounds determined from each repetition so as to determine the amount of the buffering inorganic carbon compounds present in the liquid sample therefrom.

In some exemplary embodiments the buffering inorganic carbon compounds are hydrogen carbonate and the organic acids are volatile fatty acids.

In still further exemplary embodiments the method comprises determining a ratio of the concentration of organic acids or volatile fatty acids in the liquid sample to the concentration of the buffering inorganic carbon compounds or hydrogen carbonate in the liquid sample. A digester may be considered to be in good health when the ratio of the concentration of the volatile fatty acids in the liquid sample to the concentration of hydrogen carbonate in the sample is less than about 0.5.

In some exemplary embodiments, the method is provided wherein the agitating is provided sufficiently so as to substantially inhibit components of the liquid sample from adhering to the sample chamber walls. Furthermore, agitation is provided in order to ensure substantially complete reaction of acid and HCO₃⁻.

In some exemplary embodiments of the method, the gas pressure in the sample chamber gas head-space is substantially provided by an increase in carbon dioxide resultant from the reaction of the acid with hydrogen carbonate in the liquid sample.

In some exemplary embodiments, the method, further comprises the collection and removal of the organic acids by a gas condenser unit.

In some exemplary embodiments, the method further comprises a distillation step for removing at least a portion of water collected with the organic acids.

In some exemplary embodiments of the method, the at least a portion of the organic acids from the sample chamber gas head-space are analyzed by a Fourier Transform Infrared (FT-IR) Spectrometer, a Fourier Transform Near Infrared Spectrometer (FT-NIR), a Near Infrared (NIR) Dispersion spectrometer, Gas Chromatography (GC), GC-FED, High Performance Liquid Chromatography (HPLC), High Performance Liquid Chromatography (HPLC) configured with an ultraviolet detector, or a tuned laser-diode combination detection system.

In some exemplary embodiments the method is coordinated by an automated control module for coordinating the introduction of the liquid sample into the sample chamber, the addition of acid into the sample chamber, agitation of the liquid sample, heating the liquid sample, analysis of the liquid and/or the processing module in a predetermined sequence. The processing module being provided for determining the ratio of the volatile organic acids to hydrogen carbonate in the liquid sample from the determined pressures and volatile fatty acid analysis. Furthermore, in some exemplary embodiments the automated control module may also coordinate the inlet of a base into the sample chamber.

In some exemplary embodiments of the method, the liquid sample is heated.

In some exemplary embodiments the method further comprises:
i) adding a desired amount of a base to the liquid sample, after removing the at least a portion of the organic acid, so as to raise the pH and produce ammonia wherein at a least a portion of the ammonia is released into the sample chamber head-space; and
ii) determining a second gas pressure and/or obtaining light absorption readings in the sample chamber head-space so as to determine the concentration of ammonium in the liquid sample.

In some exemplary embodiments, the base increases the pH of the liquid sample to at least 10.

In some exemplary embodiments, the method further comprises returning the liquid sample to the anaerobic digester.

In some exemplary embodiments, the method further comprises adjusting the reaction parameters of the anaerobic digester according to the ratio of the concentration of the organic acids or volatile fatty acids and the buffering inorganic carbon compounds or hydrogen carbonate in the liquid sample so as to maintain a substantially constant anaerobic digestion process.

In some exemplary embodiments, the method further comprises monitoring the ratio of the concentration of the organic acids or volatile fatty acids in the liquid sample to the concentration of the buffering inorganic carbon compounds or hydrogen carbonate over a given time period.

In still yet another exemplary embodiment, there is provided a computer-readable medium having statements and instructions stored therein for implementation by a processor of an anaerobic digestion process monitoring device operatively coupled to an anaerobic digestion system, the statements and instructions for operating components of the system to provide a substantially real-time quantification of compounds in an anaerobic digestion process of the system for identifying a health of the anaerobic digestion process by automatically:
a. combining a liquid sample from the system and a predetermined amount of an acid into a sealable sample chamber so that a gas head-space remains in the sample chamber;
b. agitating the liquid sample and the acid combination while monitoring a pH thereof;
c. determining a gas pressure in the sample chamber gas head-space upon the pH reaching about 4.4 or less;
d. determining a concentration of buffering inorganic carbon compounds in the liquid sample as a function of the gas pressure;
e. heating and further agitating the combination;
f. determining a concentration of organic acids released to the sample chamber gas head-space;
g. determining a concentration of organic acids in the liquid sample as a function of the determined concentration of organic acids released to the sample chamber gas head-space;
h. determining a ratio of the concentration of organic acids in the liquid sample to the concentration of buffering inorganic carbon compounds in the liquid sample for use as an indication of the health of the anaerobic digestion process.

In some exemplary embodiments, the computer readable medium further comprises statements and instructions for automatically adjusting reaction parameters of the anaerobic digestion system as a function of the ratio so as to maintain a substantially constant anaerobic digestion process. Furthermore, the computer readable medium may comprise statements and instructions for comparing the ratio to a preset ratio below which the anaerobic digestion process is considered to be in good health. In still further exemplary embodiments, the computer readable medium comprises statements and instructions for repeatedly determining the gas pressure, determining an amount of buffering inorganic carbon compounds evolved to carbon dioxide for each repetition as a function thereof, and determining the concentration of buffering inorganic compounds in the liquid sample as a function of a sum of each such amount.

In another exemplary embodiment, there is provided a computer-readable medium having statements and instructions stored therein for implementation by a processor of an anaerobic digestion process monitoring device operatively coupled to an anaerobic digestion system, the statements and instructions to provide a substantially real-time quantification of compounds in an anaerobic digestion process of the system for identifying a health of the anaerobic digestion process by automatically:
a. monitoring pH of a liquid sample from the system when combined and agitated with a predetermined amount of acid within a sealed sample chamber;
b. determining a gas pressure formed in a sealed sample chamber gas head-space upon pH reaching about 4.4 or less;
c. determining a concentration of buffering inorganic carbon compounds in the liquid sample as a function of the gas pressure;
d. determining a concentration of organic acids released to the sample chamber gas head-space upon further agitation and heating of the combination;
e. determining a concentration of organic acids in the liquid sample as a function of the determined concentration of organic acids released to the sample chamber gas head-space;
f. determining a ratio of the concentration of organic acids in the liquid sample to the concentration of buffering inorganic carbon compounds in the liquid sample for use as an indication of the health of the anaerobic digestion process.

Other aims, objects, advantages and features of the invention will become more apparent upon the reading of the following non-restrictive description of specific embodiments thereof, given by way of example only with reference to the accompanying drawings.

### BRIEF DESCRIPTION OF THE FIGURES

FIG. 1 is a schematic representation of an exemplary embodiment of the device relative an anaerobic digester;

FIG. 2 is a schematic representation of an exemplary embodiment of the device; and

FIG. 3 is a flow chart diagram indicating steps of an exemplary method for extracting information regarding the concentration of compounds present in an anaerobic digestion process.

### DESCRIPTION OF THE EXEMPLARY EMBODIMENTS

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical couplings. Furthermore, and as described in subsequent paragraphs, the specific configurations illustrated in the drawings are intended to exemplify embodiments of the invention. However, other alternative mechanical or other configurations are possible which are considered to be within the teachings of the instant disclosure.

Exemplary embodiments disclosed herein may be used to extract information automatically on-site in real-time or at a given time point so as to aid in determination of the “health” or a ratio of FOS/TAC for a given AD digester. The device and accompanying method described herein utilizes measurements of total organic acids (FOS), which may for example, be VFA's and buffering inorganic carbon compounds (TAC), which may, for example, be hydrogen carbonate. These individual VFA, and HCO₃⁻ concentrations, and in some instances ammonium (NH₄⁺) concentration information may provide the operator with the ability to load the digester at maximum efficiency without exceeding VFA and/or ammonium toxic threshold values, maintain an adequate buffering capacity in the digestion process and avoid low pH conditions, which may cause AD process failure. Therefore, the device and method may provide information about the health of a digester so as to allow an operator to maintain a stable optimized AD system which maximizes the profitability of the AD installation. As noted above, the health of a digester may be determined by the ratio of FOS to TAC wherein a value of less than 0.5 indicates the AD digester is in good health and substantially optimized in terms of the quantity of VFA and HCO₃⁻ buffering capacity.

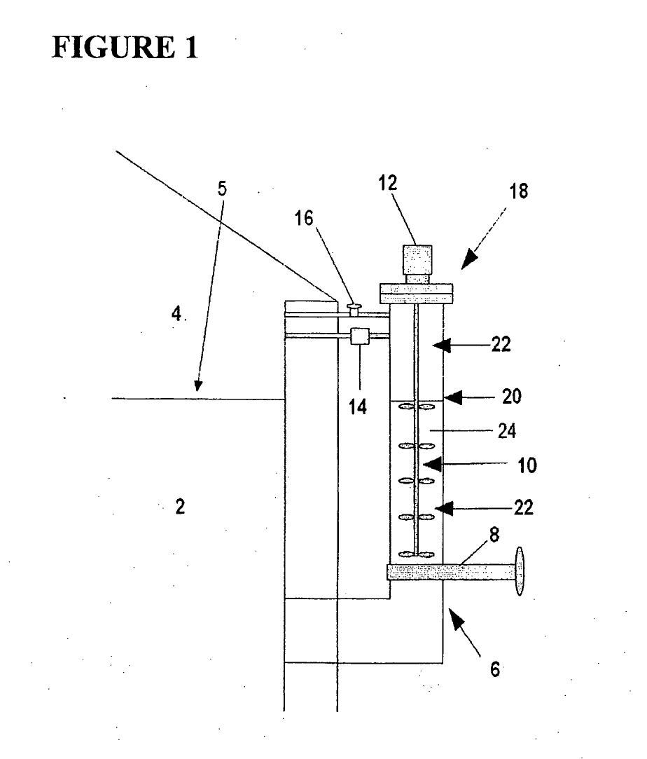

For the sake of clarity the description has been divided into sections, the first section describes in general terms the basic installation configuration and the mechanical components, as well as their respective functions. The second section describes the configuration of the components within and exemplary embodiment of the device 18 (FIG. 1) used for sample processing. The third section describes an exemplary method of operation and how an exemplary embodiment of the device 18 extracts the individual VFA, NH₄⁺ and HCO₃⁻ concentration information from an active AD process. The fourth section describes the data computation and analysis for a given time point so as to determine the general health of the AD digestion process.

### Basic Installation Configuration and the Mechanical Components

The following description generally refers to components of the device 18 and provides a description of the component's function within the overall device 18 with reference to FIG. 1.

The anaerobic digestion process 2 takes place in an anaerobic digester having a biogas-filled head-space 4. The device 18 is mounted at such a height relative to the anaerobic digester liquid level as is shown at 5 in FIG. 1 to ensure that under equalized pressure there is an adequate head-space 22 in the sample chamber 20.

A ˜15 mm tube with 90 degree elbow made of chemically inert material that can efficiently conduct heat is used for a liquid transfer portion 6, preferably a high grade stainless steel, such as 316 so as to allow the transfer of a liquid sample 24 from the anaerobic digester into a sample chamber 20. However, other sizes and materials may be used in various embodiments if required or preferred.

A valve 8 appropriately sized for the liquid transfer portion 6, as noted above, operable between an open position and a closed position is used to isolate the liquid sample 24 from the main AD process. The valve 8 may, for example, be a gate valve and in the currently disclosed exemplary embodiment, a ˜15 mm valve.

In the exemplary embodiment of FIG. 1, an agitator 10 is mounted substantially in the centre of the sample chamber 20 and ends just before reaching the valve 8. However, in some exemplary embodiments, the agitator 10 may be off-set from the centre of the sample chamber, or located near a wall thereof. In some exemplary embodiments, the agitator 10 diameter is reduced in size relative to the ˜15 mm housing tube to allow a convective motion of the material in the sample chamber 20. The agitator 10 is cycled during the function of the foregoing method so as to ensure substantially complete mixing of the sample 24. In other contemplated embodiments, not shown, the sample chamber itself may be shaken so as to agitate the sample.

In some exemplary embodiments, the agitator 10 may be powered by an external electrical motor 12.

A gas pump 14 is used to pump biogas from the system into the sample chamber head-space 22 of the device 18. This effectively pushes the material in the sample chamber 20 out and back into the AD process when the valve 8 is open.

A gas valve 16 opens to release the biogas back into the head-space of the main AD process 2, while equalizing the pressure between the sample chamber head-space 22 and the AD process head-space 4. A sample 24 enters the sample chamber and stops at the liquid level of the main AD process as shown in the figures owing to the fluid equilibrium. Thus, the device 18 may be installed as noted above and shown, for example, in FIG. 1. The gas valve 16 is then closed during the pressurization portion as mentioned above. Liquid from the anaerobic digester is cycled through the sample chamber 20 several times using this process (the sample chamber flush) before running the sample processing method, as described below, so as to provide a fresh sample representative of the state of the AD digester process at the given time point is in the sample chamber 20 for analysis.

### Liquid Sample Processing Configuration

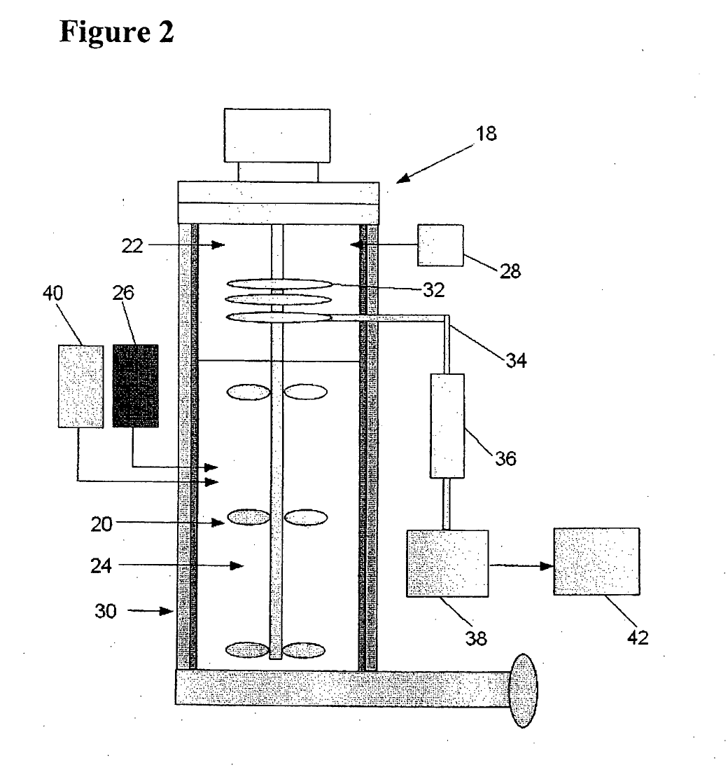

With reference to FIG. 2, an exemplary embodiment of the device 18 is described. An acid inlet 26 is used to introduce a predetermined or desired amount of acid such as, but not limited to, sulfuric acid to the sample 24 following the sample chamber flush as described above and the sample 24 has been loaded in to the sample chamber 20. At this stage, the liquid transfer gate valve 8 and the gas valve 16 (FIG. 1) in a closed conformation. For example, in some exemplary embodiments, hydrochloric acid or phosphoric acid or an acid having a pKa value lower than 4.0 may be introduced to the liquid sample 24. This liquid sample 24 and acid combination is agitated continuously and the sample pH is decreased to a value of 4.4 or lower. The addition of an acid causes a major portion of the HCO₃⁻ present in the sample to form CO₂ and H₂O. This results in CO₂ gas exiting the sample and pressurizing the sample chamber head-space 22 with CO₂.

A pressure sensor 28 is provided and is operable to quantify the resultant pressure in the sample chamber head-space 22 caused by the acid addition and mixing. This pressure data is used to calculate the original HCO₃⁻ concentration that was in the sample.

The sample chamber 20 including head-space 22 is configured with a heating jacket 30, in the exemplary embodiment shown in shown in FIG. 2, thermostat and insulation. Once the sample chamber head space 22 is pressurized and the HCO₃⁻ concentration is quantified by way calculating information received from the pressure sensor 28 as described, for example above and further below, the sample chamber 20 is then heated and continuous agitation is provided. The sample is heated at temperatures below about 70° C., but sufficient so as to cause the release of VFA's from the liquid sample to the sample chamber head-space 22, and mixing or agitation is also provided to reduce the risk of sample material adhering to the sample chamber walls and the agitator 10. This relatively higher temperature, as compared to the sample temperature used for the process and HCO₃⁻ quantification, and mixing effectively increases the VFA concentration in the head-space 22 of the device 18. The low pH produced by the inlet of acid via the acid inlet mechanism 26 also increases the volatile nature of the acids of interest since they are, at this stage in the process, predominately in a non-ionized form. The aforementioned two steps increase the reproducibility of the analysis procedure, since temperature and pH are parameters that dictate the volatile nature of VFA's.

Although the above exemplary embodiment of the device 18 is described wherein the sample 24 is heated by means of a heating jacket 30 applied the exterior of the sample chamber 20, in some exemplary embodiments, not shown, it may be desirable to transfer heat to the sample 24 via other means. For example, the sample may be heated directly using a heating element operably coupled to the sample chamber or burner applied to the sample chamber or substantially submerging a heating element in the sample. In various applications, the desired mode of heating the liquid sample 24 may be determined on an individual basis according to the material being digested in the anaerobic digester so as to optimize the release of the VFA's into the sample chamber head space 22.

A gas condenser unit 32 mounted in the sample chamber head-space 22 of the device 18 is then used to condense the water vapour evolved and thus volatized acids. Other gas condensing methods may be used, for example, the gas may exit the sample chamber to an external condensing unit and in some exemplary embodiments, the condensate may further be distilled at 36. Regardless, the condensate water and VFA mixture is collected via a transfer portion 34 to provide an adequate sample volume for the VFA analysis portion of the method by a detection module 38.

In addition to the condensate collection step and analysis noted above, or in the alternative to, in some exemplary embodiments VFA's can be measured directly in the head-space 22 via the light absorption method of Beer's Law so as to determine the concentration of VFA's and thus FOS in the sample.

The water and VFA rich condensate is then transferred out of the head-space 22 to an optional distillation step of the method or analyzed directly, dependent on the detection limits.

In some exemplary embodiments, a distillation mechanism is used to increase the individual VFA concentrations by a predetermined factor. This potentially required step effectively decreases the detection limit for each individual VFA by removing the water and concentrating the VFA's. The distillation step may be optimized to work with the detection module 38 that is used and is optional depending on desired detection limits. Furthermore, in some exemplary embodiments, it may be desirable to adjust the pH of the condensate to a basic pH in order to aid with the distillation and recovery of VFA's. However, as noted above, this distillation step may not be required.

The VFA condensate, whether distilled or undistilled, may, at this stage in the process, be introduced to and analyzed in a detection system. Detection systems for determining the concentration of VFA's in a given sample, may include, but are not limited to, Fourier Transform Infrared (FT-IR) Spectrometer, FT-NIR, NIR Dispersion Spectrometers, Gas Chromatography (GC) techniques such as GC-FED, High Performance Liquid Chromatography (HPLC) configured with a UV detector, tuned laser-diode combination detection system, etc.

In some exemplary embodiments, once the individual VFA condensate sample is collected and transferred for analysis, a base is added and mixed with the liquid sample 24 via a base input mechanism 40 operably coupled to an inlet into the sample chamber 20. In such exemplary embodiments, the base is added and mixed with the sample to bring the pH of the liquid sample to a pH of at least 10 and preferably higher than 11. The CO, that is still present in the sample chamber head-space 22 is then re-absorbed by the liquid sample 24 and the ammonium (NH₄⁺) in the liquid sample is then converted to ammonia (NH₃), which then pressurizes the head-space 22. Adequate time is given to allow the CO₂ to re-enter the liquid sample 24 and the NH₃ to exit the liquid sample 24. Once the reaction has stabilized a pressure reading is taken to calculate the original NH₄⁺ concentration using a process similar to that described below with respect to the calculation of the buffering inorganic carbon compounds. However, it may be more desirable, some exemplary embodiments, to determine the original concentration of NH₄⁺ using IR absorption techniques, or other light absorption techniques of the head-space 22 contents. This alkalization step in the process may also prepare the liquid sample 24 to re-enter the anaerobic digestion process, since the AD process runs optimally on the basic side of neutral pH, reintroducing at a low pH may, in some cases, have a negative effect on the anaerobic digester. Therefore, re-introducing the processed sample at basic pH level may be advantageous to the main anaerobic digestion process.

The automated control module (42 in FIG. 2) operates the mechanical components such as valves, pumps, agitator, heater, acid input, base input as well as logging and processing the data. As will be appreciated by the skilled artisan, the control module 42 may comprise one or more processors operatively coupled to one or more computer-readable media having statements and instructions stored thereon for implementation by the processor to operate such components and/or perform various calculations and analyses in identifying and/or monitoring a health of the anaerobic digestion system's process. Optionally the control module 42 may be further configured to automatically adjust parameters of the process as a function of this identified health to maintain a substantially constant anaerobic digestion process in the system.

### Method Description

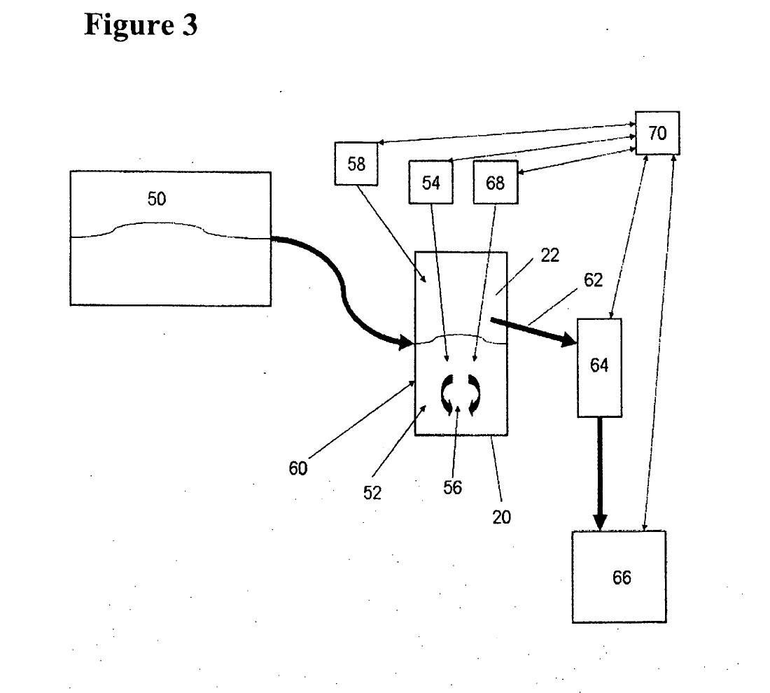

FIG. 3 illustrates in an exemplary flow diagram format of the steps of an exemplary embodiment of a method used to determine the buffering inorganic carbon compound or hydrogen carbonate (HCO₃⁻) concentration, and organic acids or individual VFA concentration and optionally the ammonium (NH₄⁺) concentration from an active anaerobic digestion process in conjunction with an embodiment of the device 18 as described above. Parts of the exemplary method are described individually so as to provide the reader with an overall understanding of the process.

With reference to FIG. 3, a liquid sample 52 is extracted from an anaerobic digestion process at 50 and enters a selectively sealable sample chamber 20 that has an adequate gas head-space 22. In some exemplary embodiments the head-space 22 volume is sufficiently large in relation to the liquid sample 24 volume such that the majority of CO₂ remaining in the liquid sample 24 is small and under increased pressure most of the CO₂ is released to the head-space 22. In other words, the head-space 22 volume is sufficiently large in relation to the liquid sample 24 volume in order to keep at minimum the amount of CO₂ remaining in the liquid sample 24. The liquid sample 52 is then sealed into the sample chamber 20 with an adequate gas head-space 22.

A desired amount of acid is then added to the liquid sample 52 to lower the liquid sample pH to a pH of at least 5.5, but preferably 4.4 or lower at 54. The amount of acid can be a predetermined bolus known to be sufficient so as to decrease the pH of the sample to the desired pH level.

The acid and liquid sample 52 is then continuously agitated at 56 so as to effectively mix the acid and liquid sample combination. In preferred embodiments, continuous agitation is applied throughout the process once the liquid sample 52 is located in the sample chamber 20.

The addition of acid to the liquid sample 52 causes the HCO₃⁻ present in the sample to saturate with protons (H⁺) and form carbon dioxide gas (CO₂) and water (H₂O). The CO₂ gas leaves the liquid sample 52 and pressurizes the gas head-space 22 since the entire sample chamber is sealed. Once this reaction has stabilized a first head-space pressure reading is obtained via a pressure sensor 58 and is used to determine the original HCO₃⁻ concentration within the liquid sample 52 therefrom.

Once the pressure reading has been obtained the sample chamber 20 is then heated at 60 to a predetermined temperature. Temperatures below about 70° C. are typically used to avoid the liquid sample 52 from adhering to sample chamber walls and the agitator 10. Higher temperatures may be used if steps are taken to mitigate the risk of the sample substrates sticking to the components of the device 18. The low pH condition created at 54 and the increased temperature increases the volatile nature of the VFA's. Setting the temperature and pH to achieve the same values in subsequent runs increases the reproducibility of the instant method for quantifying the individual VFA's.

Once the gas head-space 22 of the sample chamber 20 has been enriched with VFA's a condenser unit with collection means at 62, is activated to condense the VFA's and water molecules that are present in the gas head-space 22. Once an adequate condensate sample volume is collected it is then analyzed, or optionally first transferred to a distillation step at 64.

As noted above, the condensate sample is optionally distilled so as to remove at least a portion of the water from the VFA and water condensate mixture. This effectively increases the concentration of the individual VFA's so as to allow detection of the VFA's within the detection limits of the detection devices. This step may be fine-tuned to work the selected analysis method and, as noted, may be optional if the concentration of the VFA's is within the required detection limits.

The enriched VFA combination with water sample is then analyzed by a detection module such as, but not limited to, Fourier Transform Infrared (FT-IR) Spectrometer, a Fourier Transform Near Infrared Spectrometer (FT-NIR), a Near Infrared (NIR) Dispersion spectrometer, a Gas Chromatographer (GC), GC-FID, a High Performance Liquid Chromatography (HPLC) system, a High Performance Liquid Chromatography (HPLC) system configured with an ultraviolet detector, or a tuned laser-diode combination detection system. This detection module quantifies the concentration of the each individual VFA's and/or the total organic acid concentration present in the sample. The unit is calibrated to quantify the amount of each VFA that was present in the original liquid sample from the anaerobic digestion process.

In some embodiments, a base is then added to the sealed sample chamber 20 at 68 to bring the pH to above 10 and preferably above 11. The heat source is turned off to lower the liquid sample 52 temperature. The CO₂ present in the gas head-space 22 then re-enters the liquid sample 52 and the ammonium (NH₄⁺) present in the liquid sample is converted to its ammonia form (NH₃) and exits the liquid sample and pressurizes the gas head-space 22. Adequate time is given to allow this reaction to proceed and to stabilize. Once a stabilized condition is achieved, a pressure reading is taken and used to determine the amount of ammonium that was originally present in the liquid sample 52 using the aforementioned, and below described calculations for the pressure-mole correlation method similar to that described to the determination of the concentration of HCO₃⁻. This step also prepares the liquid sample to be re-introduced to the anaerobic digestion process, since it is now basic and the process performs optimally on the basic side of neutral pH. Once the NH₄⁺ concentration is determined through the pressure sensor reading at 58 the sample is then transferred back to the anaerobic digestion process.

In some embodiments, a control module 70 operates all of the above steps automatically and performs all the data processing and relays the information in an easy to understand format so that is understood by the operator if any corrective action is needed.

The method described above is repeated to acquire the desired time resolution and data is collected at 66 so as to perform the data computation and analysis as described below.

### Data Computation and Analysis

Following the addition of the acid to the liquid sample 24 in the sample chamber 20, wherein the volume of the sample is known, the resultant CO₂ gas-generated pressure in the sample chamber head-space 22 is noted. Once the acid is introduced into the sample while being continuously agitated, the reaction is allowed to proceed for a given time period, for example, 10 minutes, in order to allow for the reaction to reach a pressure equilibrium prior to a pressure value being taken. In some embodiments, the pressure is released and the sample chamber head-space is repressurized such that additional pressure readings can be taken. In some exemplary embodiments, multiple pressure readings may be taken for use in the following calculations to determine the concentration of the buffering inorganic carbon or HCO₃⁻ present in the initial sample. Furthermore the time allotment for the reaction to reach the pressure equilibrium for each pressure reading may be variable, for example more or less than 10 minutes, as required. The ideal gas law is then used to calculate the amount of moles of CO₂ in the headspace and thus the number of moles of HCO₃⁻ (TAC) consumed by the addition of the acid. Using:

PVhs=nRT, Equation 1

where:
P=pressure in Pa;
Vhs=volume of the sample chamber head space;
R=the ideal gas constant (8.3145 J/mol K);
T=temperature of the sample in Kelvin; and
n=moles of CO₂ in evolved to the sample chamber head-space,
and using a 1:1 ratio of CO₂ evolved to the sample chamber headspace, n also equals the number of moles of HCO₃⁻ consumed during the acidification step (head-space pressurization step) of the sample to produce CO₂ in the headspace.

The mass of HCO₃⁻ consumed during the head-space pressurization step is determined by Equation 2 as below.

Mass of HCO₃⁻=moles of HCO₃⁻×Molar Mass of HCO₃⁻, Equation 2

where:
Mass of HCO₃⁻=mass of Mass of HCO₃⁻ in grams acidified to produce CO₂ in the headspace pressurization step;
moles of HCO₃⁻=moles of HCO₃⁻ in aqueous sample acidified to evolve CO₂, n value from Equation 1; and
Molar Mass of HCO₃⁻ the molar mass of HCO₃⁻, 61.01684.

As noted above, successive pressure readings may be taken, discharging and allowing the system to repressurize for about 10 minutes between pressure readings. However, the time may be variable, as noted above, dependent on the particular anaerobic digester, process and sample being tested. Using Equations 1 and 2 above, and the amount of CO₂ in the head-space for each pressurization is determined and the pressure readings are summed. For example, in some exemplary embodiments this process is repeated 6 times. However, it may be desired, in certain applications, to repeat the process more or less times dependent on a given AD process and digester installation of the device 18.

Following the determination of the mass of CO₂ evolved to the headspace, and thus the HCO₃⁻ in the sample, a final calculation is made to determine substantially the amount of CO₂ that is remaining the in the liquid sample and not evolved to gas. A final pressure reading is taken and in the number of moles of CO₂ in the headspace is determined using Equation 1, as above. Using the number of moles of CO₂ in the headspace from the final pressure reading, the concentration of CO₂ in the headspace is determined using Equation 3 as below:

C=n/Vhs, Equation 3

where:
C=concentration of CO₂ in moles/L in the final pressure reading head-space;
n=moles of CO₂ as determined using Equation 1 for the final pressure reading; and
Vhs=volume of the sample chamber headspace in litres.

Now, the number of the CO₂ remaining in the sample can now be determined using Henry's Gas Law using Equations 4 and 5, as below.

KH,cc32 Caq/Cg, Equation 4

where
KH,cc=Henry's Gas Law constant for CO₂ at T=298° K (0.8317);
Caq=Concentration of CO₂ in the liquid sample; and
Cg=Concentration of CO₂ in the sample chamber headspace as determined from Equation 3.
The number of moles of CO₂ remaining in the liquid sample can then be determined using Equation 5.

nCO₂aq=Caq×V, Equation 5

where:
nCO₂aq=the moles of CO₂ in the liquid sample;
Caq=Concentration of CO₂ in the liquid sample, from Equation 4; and
V=the volume of the liquid sample in litres.

As noted above, using a 1:1 ratio of CO₂ evolved from the acidification step to HCO₃⁻, by summing the values of the amount of moles of CO₂ determined to be present in the sample chamber head-space after each repressurization cycle (from Equation 1 for each cycle) and the amount of CO₂ found to be present in the liquid sample following the final pressure reading, the amount of HCO₃⁻, and thus the buffering capacity in the initial sample can be determined. Equation 6 below provides a calculation for the determination of the initial HCO₃⁻ concentration of the present in the initial sample from the pressure readings and calculations.

CHCO₃=MHCO₃/V, Equation 6

where:
C HCO₃=Concentration of HCO₃⁻ present in the initial liquid sample;
M HCO₃=Total mass of HCO₃⁻ as calculated and summed from each pressure reading in grams; and
V=Volume of the initial sample in litres.
Therefore, as per the methodology provided above, initial concentration of HCO₃⁻ (TAC) present in the sample, and thus the buffering capacity of the anaerobic digester is determined for a given time point.

Once the pressure values are used to determine the concentration of HCO₃⁻ present in the liquid sample, as noted above, the pressure in the sample chamber head-space 22 is relieved and the sample temperature is raised to about 70° C. while agitation continues, the condenser 32 begins to collect condensate having VFA's contained therein. Once a sufficient amount of condensate is collected, it can be analyzed using one of the methods noted above to determine the concentration (mg/l) of VFA's (FOS) contained therein.

Once the concentrations of TAC and FOS are determined; the ratio of FOS/TAC is calculated to provide a value which, as noted above, provides an indication of the general health of the AD digestion process at a given time point. Using data from multiple time points, a trend of the general health of the AD process can be monitored. In some embodiments a data processing module may be used to collect, analyze and calculate the data from the pressure sensor as well as the organic acid analysis so as to provide the FOS/TAC ratio. This may be further coordinated by an automated control module 70, as noted above.

### Example 1

The following is an example of data computation and analysis in order to provide an indication of the health of an exemplary AD digestion process.

3 liters of a liquid sample was introduced into the sample chamber and the pressure in the sample chamber head-space was allowed to equilibrate with that of the anaerobic digester head-space. The temperature of the liquid sample was 38° C. (311K). 250 ml of 1.0M H₂SO₄ was introduced into the sample chamber to mix with the sample. This amount of H₂SO₄ was introduced since it was known that the dissolved HCO₃⁻ in the sample was less than 7,500 mg/l and this would reduce the pH of the sample to less than 4.00. The addition of this amount of acid drives substantially all of the dissolved HCO₃⁻ into CO₂ gas and minimizes CO₂ from reacting with water to reform HCO₃⁻. As noted above, the CO₂ exits the liquid sample and pressurizes the sample chamber head-space and an equilibrium is created between the amount of CO₂ in the sample chamber head-space and the liquid sample. After a period of 10 minutes, which allows for the establishment of the aforementioned CO₂ equilibrium, a pressure reading of the head-space pressure was taken. As noted above, with respect to Equation 1, a pressure reading was taken and the system was depressurized and then allowed to repressurize for 10 minutes wherein this process was repeated 6 times for the current exemplary embodiment so as to obtain several pressure readings for the calculations of the concentration of HCO₃⁻ in the sample. Each pressure reading was then separately used for the calculations with respect to Equations 1 and 2, as explained above and provided below for exemplary purposes. A final pressure reading was then taken to calculate the amount of CO₂ remaining in solution using Equations 3, 4 and 5. For exemplary purposes, a first pressure reading and a final pressure reading is shown below with corresponding data and calculations of an exemplary determination of the amount of HCO₃⁻ present in the exemplary sample. As noted above, the calculated value for CO₂ concentration in the sample chamber head-space is then presumed to be in a 1:1 ratio with HCO₃⁻ to determine the moles of HCO₃⁻ there were consumed to evolve the CO₂ during the sample acidification, and thus the amount of HCO₃⁻ present initially in the sample. As a point of note, only the final pressure measurement utilizes Henry's Gas Law to determine the concentration of CO₂ which remains dissolved in the liquid sample.

For example, 10 minutes following the addition of H₂SO₄ to the sample, a pressure reading of 102,731 Pa was taken in a sample chamber head-space volume of 0.0038 m³ and the moles of CO₂ present in the sample chamber head-space was calculated using Equation 1, as follows:

102,731×0.0038=n×8.314×311

390.381/2585.653=n

n=0.151. Therefore in the sample chamber head-space for the first pressure reading there was 0.151 moles of CO₂ present. The process was repeated 6 more times so as to determine the amount of moles of CO₂ present for the summation (data not shown). The mass of HCO₃⁻, was then determined as follows using a 1:1 consumption relation of HCO₃⁻ to CO₂ from the pressure reading using Equation 2:

Mass of HCO₃⁻=0.151×61.01684

Mass of HCO₃⁻=9.21 g; Therefore, 9.21 g of HCO₃⁻ was used to evolve the CO₂ for the first pressure reading. Although the data is not show, these calculations were repeated for the 6 repetitions, which when summed together and resulted in 15.34 g of HCO₃⁻. The amount of HCO₃⁻ present in the liquid sample from the final pressure reading was then added to this number to arrive at a mass of 15.75 g of HCO₃⁻ being present in the initial liquid sample.

In order to determine the amount of HCO₃⁻ remaining in the liquid sample, the final pressure reading of 6894 Pa was taken and the calculations performed as follows using Equation 1:

6894×0.0038=n×8.314×311

26.196/2585.654=n

n=0.010. Therefore 0.010 moles of CO₂ were present in the sample chamber headspace for the final pressure reading and the concentration of CO₂ in the sample chamber headspace was thus calculated as follows using Equation 3:

C=0.010/3.8

C=2.67×10⁻³. Therefore moles 2.67×10⁻³ of CO₂ were present in the sample chamber head-space for the final pressure reading and using Equation 4 with Henry's Gas Law constant the amount of CO, remaining in the liquid was determined as follows:

0.8317=Caq/2.67×10⁻³

0.8317×2.67×10⁻³=Caq

Caq=2.22×10⁻³. Therefore in the liquid sample there remained 2.22×10⁻³ moles per litre of CO₂ and using Equation 5, as follows, it was determined the 0.0065 of CO₂ and thus HCO₃⁻ remained in the liquid sample:

nCO₂aq=Caq×V

nCO₂aq=2.22×10⁻³×3

nCO₂aq=0.0065. Therefore 0.0065 of CO₂, and thus HCO₃⁻ remained in the liquid sample.

The initial concentration of HCO₃⁻ present in the sample was then calculated as follows, using Equation 6 where the summed values of HCO₃⁻ from the pressure readings and the CO₂ remaining in the liquid samples was determined to be 15.75 g:

CHCO₃=15.75/3

C HCO₃=5.25 g/L. Therefore in the liquid sample there was initially present 5.25 g/L HCO₃⁻, and therefore TAC is considered to be 5.25 g/L, as noted above.

Following the determination of the initial concentration of HCO₃⁻ (TAC) present in the sample, the pressure was relieved from the sample chamber bead-space and the temperature of the sample was raised the 70° C. and maintained during agitation of the liquid sample. A condensed water sample containing VFA's (also termed organic acids or FOS), or condensate, was collected by the gas condenser unit. The organic acids are volatized by the high temperature and acid conditions of the liquid sample at this stage of the process. The condensate was analyzed for both total and individual organic acid content. The acid amounts were calibrated against known standards to determine the original amount of acid in the liquid sample. In the case of the current exemplary embodiment, the total acid (FOS) content was 1390 mg/l, with acetic acid comprising 659 mg/l, propionic acid comprising 48 mg/l and butyric acid comprising 683 mg/l, as measured by HPLC methods. Total organic acid concentration (FOS) was then determined by adding concentrations determined for the individual acids.

Therefore in the instant exemplary embodiment, the FOS/TAC was found to be as follows:

FOS=1309 mg/l, TAC=5250 mg/l

1309 mg/l/5250 mg/l=0.25. Therefore since, as noted above, the FOS/TAC ratio is below 0.5, the health of the current exemplary AD digestion process was considered good for the particular liquid sample. The preceding is provided for exemplary purposes to provide an understanding of the methodologies and calculations disclosed herein so as to determine the health of an anaerobic digester at a given time point using the device 18. It should be noted that the health of an anaerobic digester may be monitored over a given period time and that trends observed are composed of several sample time points so as to monitor the digester's health over time.

### Example 2

Labour-intensive Example 2 is an example of a prior art method for determining the health of an anaerobic digester using the same liquid sample as used in Example 1 and is provided for comparison purposes. Example 2 is provided solely for the purposes of illustration of the currently disclosed device 18 and method to that of a prior art method.

A 50 ml liquid sample was taken from the digester and placed in a beaker. Under constant stirring conditions, a pH reading of the sample was taken and a titration with 0.1M H₂SO₄ was begun so as to lower the pH from an initial reading of 7.00 to 5.00. In Example 2, 29.9 ml of H₂SO₄ was required to lower the pH. The titration was then continued to reduce the pH from 5.00 to 4.40 wherein an additional 1.94 ml of H₂SO₄ was required. Using this method, the amount of TAC (HCO₃⁻) was calculated as follows:

TAC=20/50 ml of sample×(29.9 ml H₂SO₄×2×250)=5,978 mg/l of dissolved CO₂; and

FOS=20/50 ml of sample×(1.94 ml×2×1.66−0.15)×500=1,213 mg/l of total organic acids.

The FOC/TAC ratio in the prior art Example 2 is therefore 1,213 mg/l/5,978 mg/l=0.203, showing agreement the with determination made in Example 1 in that the digester is considered to be in good health.

Therefore, the device and accompanying method of the instant disclosure, Example 1, as compared to the prior art method of determining the health of a digester in Example 2, both show the exemplary digester is considered to be in good health.

Those of skill in the art will recognize certain modifications, permutations, additions and sub-combinations thereof of parts noted herein. While a device 18 and an accompanying method have been described for what are presently considered the exemplary embodiments, the invention is not so limited. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A device for monitoring compound concentrations in an anaerobic digestion system, the device comprising:
a selectively sealable sample chamber including an inlet liquid transfer portion located near a bottom portion of the sample chamber in operable communication with an anaerobic digester, the liquid transfer portion having a valve operable between an open position and a closed position for allowing the selective transfer of a liquid sample from the anaerobic digester into the sample chamber;
the sample chamber having a sample chamber gas head-space;
a gas valve capable of a gas valve-open conformation and a gas valve-closed confirmation in operable communication between the sample chamber gas head-space and an anaerobic digester head-space for selectively allowing the transfer of the liquid sample from the anaerobic digester into the sample chamber and evacuation of the liquid sample chamber;
the sample chamber having an agitator for agitating the liquid sample and a heater for heating the liquid sample;
the sample chamber having an inlet for introducing a desired amount of an acid into the liquid sample;
a pressure sensor located near a top portion of the sample chamber for measuring gas pressure in the sample chamber gas head-space and determining a concentration of buffering inorganic carbon compounds in the liquid sample therefrom;
a gas condenser unit located in the sample chamber gas head-space for condensing gases in the head-space;
a transfer portion operably coupled between the gas condenser unit and a detection module for extracting a sample of condensed gases and determining the concentration of organic acids in the condensed gases therefrom by the detection module; and
a data processing module coupled to the pressure sensor and the detection module for recording and monitoring the concentrations of the inorganic carbon compounds and organic acids in the liquid sample at a given time point.

2. (canceled)

3. The device as defined in claim 1, the agitator being motor-driven and disposed within the sample chamber to provide sufficient agitation so as to substantially inhibit components of the liquid sample from adhering to the sample chamber walls.

4. (canceled)

5. (canceled)

6. (canceled)

7. The device as defined in claim 1, wherein the gas pressure in the sample chamber gas head-space is substantially provided by an increase in carbon dioxide resultant from the reaction of the acid with the buffering inorganic compounds in the liquid sample.

8. The device as defined in claim 1, wherein the gas condenser unit further comprises distillation means for removing at least a portion of water from the condensed gases.

9. The device as defined in claim 1, wherein the detection module includes a Fourier Transform Infrared (FT-IR) Spectrometer, a Fourier Transform Near Infrared Spectrometer (FT-NIR), a Near Infrared (NIR) Dispersion spectrometer, a Gas Chromatographer (GC), GC-FID, a High Performance Liquid Chromatography (HPLC) system, a High Performance Liquid Chromatography (HPLC) system configured with an ultraviolet detector, or a tuned laser-diode combination detection system.

10. (canceled)

11. The device as defined in claim 1, further comprising a gas pump and gas transfer portion in operable communication for transferring gases from the anaerobic digester head-space to the sample chamber gas head-space so as to selectively evacuate the liquid sample from the sample chamber when the liquid transfer portion valve is in the open position.

12. The device as defined in claim 1, further comprising a base input mechanism operably coupled to the sample chamber for introducing a desired amount of a base into the liquid sample.

13. The device as defined in claim 12, wherein the device further comprises an automated control module for coordinating the inlet of the liquid sample into the sample chamber, the inlet of acid into the sample chamber, the agitator, the heater, the extraction of condensed gases, the inlet of base into the sample chamber and/or the processing module in a predetermined sequence.

14. A method for the quantification of compounds in an anaerobic digestion process for monitoring a substantially constant anaerobic digestion process, the method comprising:
a. extracting a liquid sample from an anaerobic digester and introducing the liquid sample into a selectively sealable sample chamber such that a sample chamber gas head-space remains near a top portion of the sample chamber;
b. adding a desired amount of an acid to the liquid sample so as to produce a liquid sample and acid combination;
c. agitating the liquid sample and acid combination so as to decrease the pH of the liquid to about 4.4 or less and produce carbon dioxide gas therefrom wherein at least a portion of the carbon dioxide gas is released into the sample chamber gas head-space;
d. determining a first gas pressure in the sample chamber gas head-space so as to determine a concentration of buffering inorganic carbon compounds in the liquid sample therefrom;
e. heating and agitating the sample so as to cause the release of organic acids into sample chamber gas head-space;
f. collecting and removing at least a portion of the organic acids from the sample chamber gas head-space and analyzing the concentration of the organic acids in the portion collected from the sample chamber gas head-space so as to determine the concentration of organic acids in the liquid sample therefrom; and
g. determining a ratio of the concentration of organic acids in the sample to the concentration of the buffering inorganic carbon compounds in the liquid sample so as to provide an indication of the health of the anaerobic digestion process.

15. The method as defined in claim 14, wherein (d) is repeated so as to provide more than one gas pressure reading from the sample chamber gas head-space and further comprises:
i) determining the amount the buffering inorganic carbon compounds evolved to carbon dioxide for each repetition; and
ii) summing the amount the buffering inorganic carbon compounds determined from each repetition so as to determine the amount of the buffering inorganic carbon compounds present in the liquid sample therefrom.

16. The method as defined in claim 14, wherein the buffering inorganic carbon compounds are hydrogen carbonate and the organic acids are volatile fatty acids.

17. The method as defined in claim 14, further comprising determining and monitoring if the ratio of the concentration of organic acids in the liquid sample to the concentration of buffering inorganic compounds in the liquid sample is less than about 0.5 so as to determine the health of the anaerobic digestion process; and adjusting the reaction parameters of the anaerobic digester according to the ratio of the concentrations of the organic acids and the inorganic buffering compounds in the liquid sample so as to maintain a substantially constant anaerobic digestion process.

18. (canceled)

19. (canceled)

20. (canceled)

21. (canceled)

22. (canceled)

23. (canceled)

24. (canceled)

25. (canceled)

26. (canceled)

27. The method as defined in claim 14, wherein after removing the at least a portion of the organic acids, (f) further comprises:
i) adding a desired amount of a base to the liquid sample so as to raise the pH thereof to at least pH 11 and produce ammonia wherein at a least a portion of the ammonia is released into the sample chamber head-space; and
ii) determining a second gas pressure and/or determining a light absorption reading in the sample chamber head-space so as to determine the concentration of ammonium in the liquid sample.

28. (canceled)

29. (canceled)

30. (canceled)

31. The method as defined in claim 27, wherein the method is coordinated by an automated control module for coordinating the inlet of the liquid sample into the sample chamber, the addition of acid into the sample chamber, agitation of the liquid sample, heating the liquid sample, collecting and removing the condensed gases, and/or the addition of base to the liquid sample in a predetermined sequence.

32. The method as defined in claim 14, further comprising providing a data processing module for recording the pressure sensor reading and the concentrations of organic acids and providing an indication of the health of the anaerobic digestion process.

33. (canceled)

34. (canceled)

35. (canceled)

36. A computer-readable medium having statements and instructions stored thereon for implementation by a processor of an anaerobic digestion process monitoring device operatively coupled to an anaerobic digestion system, the statements and instructions for operating components of the system to provide a substantially real-time quantification of compounds in an anaerobic digestion process of the system for identifying a health of the anaerobic digestion process by automatically:
a. combining a liquid sample from the system and a predetermined amount of an acid into a sealable sample chamber so that a gas head-space remains in the sample chamber;
b. agitating the liquid sample and the acid combination while monitoring a pH thereof;
c. determining a gas pressure in the sample chamber gas head-space upon the pH reaching about 4.4 or less;
d. determining a concentration of buffering inorganic carbon compounds in the liquid sample as a function of the gas pressure;
e. heating and further agitating the combination;
f. determining a concentration of organic acids released to the sample chamber gas head-space;
g. determining a concentration of organic acids in the liquid sample as a function of the determined concentration of organic acids released to the sample chamber gas head-space;
h. determining a ratio of the concentration of organic acids in the liquid sample to the concentration of buffering inorganic carbon compounds in the liquid sample for use as an indication of the health of the anaerobic digestion process.

37. The computer-readable medium as defined in claim 36, further comprising statements and instructions for repeatedly determining the gas pressure, determining an amount of buffering inorganic carbon compounds evolved to carbon dioxide for each repetition as a function thereof, and determining the concentration of buffering inorganic compounds in the liquid sample as a function of a sum of each such amount, comparing the ratio to a preset ratio below which the anaerobic digestion process is considered to be in good health and for automatically adjusting reaction parameters of the anaerobic digestion system as a function of the ratio to maintain a substantially constant anaerobic digestion process.

38. (canceled)

39. (canceled)

40. (canceled)

41. An anaerobic digestion process control device for operative coupling to an anaerobic digestion system, the control module comprising a processor and a computer readable medium as defined by claim 37.

42. A computer-readable medium having statements and instructions stored therein for implementation by a processor of an anaerobic digestion process monitoring device operatively coupled to an anaerobic digestion system, the statements and instructions to provide a substantially real-time quantification of compounds in an anaerobic digestion process of the system for identifying a health of the anaerobic digestion process by automatically:
a. monitoring pH of a liquid sample from the system when combined and agitated with a predetermined amount of acid within a sealed sample chamber;
b. determining a gas pressure formed in a sealed sample chamber gas head-space upon pH reaching about 4.4 or less;
c. determining a concentration of buffering inorganic carbon compounds in the liquid sample as a function of the gas pressure;
d. determining a concentration of organic acids released to the sample chamber gas head-space upon further agitation and heating of the combination;
e. determining a concentration of organic acids in the liquid sample as a function of the determined concentration of organic acids released to the sample chamber gas head-space;
f. determining a ratio of the concentration of organic acids in the liquid sample to the concentration of buffering inorganic carbon compounds in the liquid sample for use as an indication of the health of the anaerobic digestion process.

43. The method as defined in claim 15 further comprising determining and monitoring if
the ratio of the concentration of organic acids in the liquid sample to the concentration of buffering inorganic compounds in the liquid sample is less than about 0.5 so as to determine the health of the anaerobic digestion process; and adjusting the reaction parameters of the anaerobic digester according to the ratio of the concentrations of the organic acids and the inorganic buffering compounds in the liquid sample so as to maintain a substantially constant anaerobic digestion process.
